(19) United States
(12) Patent Application Publication
(10) Pub. No.: US 2020/0294198 A1
(43) Pub. Date: Sep. 17, 2020

(54) IMAGE PROCESSING APPARATUS, IMAGE CAPTURING APPARATUS, IMAGE PROCESSING METHOD, AND STORAGE MEDIUM

(71) Applicant: CANON KABUSHIKI KAISHA, Tokyo (JP)

(72) Inventor: Yohei Yamanaka, Yokohama-shi (JP)

(21) Appl. No.: 16/816,643

(22) Filed: Mar. 12, 2020

(30) Foreign Application Priority Data
Mar. 15, 2019 (JP) 2019-048745

(51) Int. Cl. G06T 5/00; G06T 5/50; H04N 5/243; H04N 5/232

(52) U.S. Cl. CPC G06T 5/001; G06T 5/50; G06T 2207/10148; H04N 5/232133; G06T 2207/20221; H04N 5/243

(57) ABSTRACT

A generation unit generates, from a first image, a second image from which a first frequency component of the first image has been removed. A correction unit generates a first correction image by adding, to the first image, a first correction component that is based on the first frequency component of the first image and a second frequency component corresponding to a lower band of the first image than the first frequency component, and generates a second correction image by adding, to the second image, a second correction component that is based on the second frequency component. The first correction component includes a component obtained by applying a first gain to the second frequency component. The second correction component includes a component obtained by applying a second gain larger than the first gain to the second frequency component.

### BACKGROUND OF THE INVENTION

### Field of the Invention

The present invention relates to an image processing apparatus, an image capturing apparatus, an image processing method, and a storage medium.

### Description of the Related Art

Technologies for locally improving the contrast of an image by generating a low frequency image from an input image and performing tone processing that uses the low frequency image are known. For example, Japanese Patent Laid-Open No. 9-163227 discloses a technology for enhancing an image, by generating a plurality of images whose resolutions differ stepwise, generating a high frequency component at each resolution based on the difference in pixel values between the images, and adding the high frequency component to the original image.

Also, technologies for generating a diorama-like image by performing image processing that partially imparts a blurred effect on the image are known. For example, Japanese Patent Laid-Open No. 2011-166300 discloses a technology for generating a diorama-like image, by performing gradual blurring processing moving away from a predetermined band-like region of the image while preserving a sense of depth and sharpness in the band-like region.

An image that has undergone blurring processing (blurred image) loses the high frequency component possessed by the original image. Thus, the contrast enhancement effect that is obtained in the case where the technology of Japanese Patent Laid-Open No. 9-163227 is applies to a blurred image is less than the contrast enhancement effect that is obtained in the case where the technology of Japanese Patent Laid-Open No. 9-163227 is applied to the original image. Accordingly, in the case where the technologies of Japanese Patent Laid-Open No. 9-163227 and Japanese Patent Laid-Open No. 2011-166300 are simply used in combination, a difference in the degree of contrast enhancement between the region that is blurred and the region that is not blurred may occur, resulting in an unnatural image.

### SUMMARY OF THE INVENTION

The present invention has been made in view of such situations, and provides a technology that, when performing image processing for enhancing the contrast of a blurred image and an original image, enables a difference in the contrast enhancement effect between the blurred image and the original image to be reduced.

According to a first aspect of the present invention, there is provided an image processing apparatus comprising at least one processor and/or circuit configured to function as following units: a generation unit configured to generate, from a first image, a second image from which a first frequency component of the first image has been removed; a correction unit configured to generate a first correction image by adding, to the first image, a first correction component that is based on the first frequency component of the first image and a second frequency component corresponding to a lower band of the first image than the first frequency component, and generate a second correction image by adding, to the second image, a second correction component that is based on the second frequency component; and a compositing unit configured to composite the first correction image and the second correction image, wherein the first correction component includes a component obtained by applying a first gain to the second frequency component, and the second correction component includes a component obtained by applying a second gain larger than the first gain to the second frequency component.

According to a second aspect of the present invention, there is provided an image capturing apparatus comprising: the image processing apparatus according to the first aspect; and an image sensor configured to generate the first image.

According to a third aspect of the present invention, there is provided an image processing apparatus comprising at least one processor and/or circuit configured to function as following units: a generation unit configured to generate, from a first image focused on a background in a shooting range, a second image from which a first frequency component of the first image has been removed; a correction unit configured to generate a first correction image by adding, to a fourth image focused on an main object in the shooting range, a first correction component that is based on the first frequency component of the first image and a second frequency component corresponding to a lower band of the first image than the first frequency component, and generate a second correction image by adding, to the second image, a second correction component that is based on the second frequency component; and a compositing unit configured to composite the first correction image and the second correction image, wherein the first correction component includes a component obtained by applying a first gain to the second frequency component, and the second correction component includes a component obtained by applying a second gain smaller than the first gain to the second frequency component.

According to a fourth aspect of the present invention, there is provided an image capturing apparatus comprising: the image processing apparatus according to the third aspect; and an image sensor configured to generate the first image and the fourth image.

According to a fifth aspect of the present invention, there is provided an image processing method executed by an image processing apparatus, comprising: generating, from a first image, a second image from which a first frequency component of the first image has been removed; generating a first correction image by adding, to the first image, a first correction component that is based on the first frequency component of the first image and a second frequency component corresponding to a lower band of the first image than the first frequency component, and generating a second correction image by adding, to the second image, a second correction component that is based on the second frequency component; and compositing the first correction image and the second correction image, wherein the first correction component includes a component obtained by applying a first gain to the second frequency component, and the second correction component includes a component obtained by applying a second gain larger than the first gain to the second frequency component.

According to a sixth aspect of the present invention, there is provided an image processing method executed by an image processing apparatus, comprising: generating, from a first image focused on a background in a shooting range, a second image from which a first frequency component of the first image has been removed; generating a first correction image by adding, to a fourth image focused on an main object in the shooting range, a first correction component that is based on the first frequency component of the first image and a second frequency component corresponding to a lower band of the first image than the first frequency component, and generating a second correction image by adding, to the second image, a second correction component that is based on the second frequency component; and compositing the first correction image and the second correction image, wherein the first correction component includes a component obtained by applying a first gain to the second frequency component, and the second correction component includes a component obtained by applying a second gain smaller than the first gain to the second frequency component.

According to a seventh aspect of the present invention, there is provided a non-transitory computer-readable storage medium which stores a program for causing a computer to execute an image processing method comprising: generating, from a first image, a second image from which a first frequency component of the first image has been removed; generating a first correction image by adding, to the first image, a first correction component that is based on the first frequency component of the first image and a second frequency component corresponding to a lower band of the first image than the first frequency component, and generating a second correction image by adding, to the second image, a second correction component that is based on the second frequency component; and compositing the first correction image and the second correction image, wherein the first correction component includes a component obtained by applying a first gain to the second frequency component, and the second correction component includes a component obtained by applying a second gain larger than the first gain to the second frequency component.

According to an eighth aspect of the present invention, there is provided a non-transitory computer-readable storage medium which stores a program for causing a computer to execute an image processing method comprising: generating, from a first image focused on a background in a shooting range, a second image from which a first frequency component of the first image has been removed; generating a first correction image by adding, to a fourth image focused on an main object in the shooting range, a first correction component that is based on the first frequency component of the first image and a second frequency component corresponding to a lower band of the first image than the first frequency component, and generating a second correction image by adding, to the second image, a second correction component that is based on the second frequency component; and compositing the first correction image and the second correction image, wherein the first correction component includes a component obtained by applying a first gain to the second frequency component, and the second correction component includes a component obtained by applying a second gain smaller than the first gain to the second frequency component.

Further features of the present invention will become apparent from the following description of exemplary embodiments with reference to the attached drawings.

### BRIEF DESCRIPTION OF THE DRAWINGS

FIG. 1 is a block diagram showing the basic configuration of an image capturing apparatus 100.

FIG. 2 is a block diagram showing a detailed configuration of an image processing unit 105 that relates to processing for generating a diorama-like image from an original image.

FIG. 3 is a flowchart of diorama-like image generation processing.

FIGS. 4A to 4E are diagrams showing an example of gains of each difference image for every reduced and enlarged image.

FIG. 5 is a conceptual diagram of processing for compositing reduced and enlarged images.

FIG. 6 is a flowchart of background blurred image generation processing.

FIGS. 7A and 7B are diagrams showing an example of screens for notifying a user that appropriate contrast correction cannot be performed.

FIG. 8 is a diagram showing an example of gains of difference images for a 1/16 reduced and enlarged image according to a second embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made an invention that requires all such features, and multiple such features may be combined as appropriate. Furthermore, in the attached drawings, the same reference numerals are given to the same or similar configurations, and redundant description thereof is omitted.

### First Embodiment

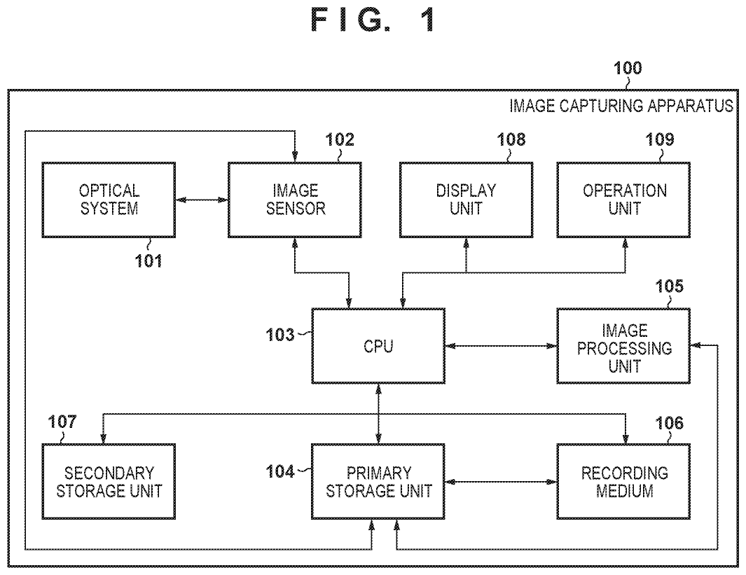

FIG. 1 is a block diagram showing a basic configuration of an image capturing apparatus 100 serving as an example of an image processing apparatus. The image capturing apparatus 100 may be any electronic device provided with a camera function, including a camera such as a digital camera or a digital video camera as well as a mobile phone with a camera function, a camera-equipped computer, or the like.

An optical system 101 includes a lens, a shutter and a diaphragm, and forms an image on an image sensor 102 with light from an object under the control of a CPU 103. The image sensor 102 includes a CCD image sensor, a CMOS image sensor or the like, and converts the light formed into an image through the optical system 101 into image signals.

The CPU 103 realizes the functions of the image capturing apparatus 100, by controlling the units constituting the image capturing apparatus 100, in accordance with signals that are input and programs stored in advance. A primary storage unit 104 is a volatile memory such as a RAM, for example, and stores temporary data and is used as a work area by the CPU 103. Also, information that is stored in the primary storage unit 104 is utilized by an image processing unit 105 or is recorded to a recording medium 106.

The image processing unit 105 creates a shot image by processing electrical signals acquired by the image sensor 102. The image processing unit 105 performs various processing on the electrical signals, such as white balance adjustment, pixel interpolation, conversion to YUV data, filtering, and image compositing.

The secondary storage unit 107 is a nonvolatile memory such as an EEPROM, for example, and stores programs (firmware) and various setting information for controlling the image capturing apparatus 100. The programs and setting information are utilized by the CPU 103.

The recording medium 106 stores image data obtained through shooting and the like that is stored in the primary storage unit 104. Note that the recording medium 106 is removable from the image capturing apparatus 100 such as a semiconductor memory card, for example, and is capable of being mounted in a personal computer or the like in order for data to be read out. In other words, the image capturing apparatus 100 has the detachable mechanism and the read/write functions of the recording medium 106.

A display unit 108 displays viewfinder images at the time of shooting, displays shot images, displays GUI images for interactive operations, and the like. An operation unit 109 is an input device group that accepts operations by the user and transmits input information to the CPU 103, and includes a button, a lever, and a touch panel, for example. Also, the operation unit 109 may include an input device that uses voice, line of sight, or the like.

Note that the user is capable of setting the shooting mode according to his or her preferences, by operating the operation unit 109. As shooting modes, there are modes corresponding to various types of images, such as more vivid images, standard images, neutral images with suppressed colors, and images with emphasis places on skin color. For example, in the case of wanting to take a close up of a person, more effective image properties are obtained, by changing the shooting mode to a portrait mode.

Also, the image capturing apparatus 100 has a plurality of image processing patterns that the image processing unit 105 applies to a shot still image or moving image. The user, by operating the operation unit 109, is capable of selecting a shooting mode associated with a desired image processing pattern. The image processing unit 105 also performs processing such as tonal adjustment that depends on the shooting mode, including image processing known as so-called development processing. Note that the CPU 103 may realize at least some of the functions of the image processing unit 105 with software.

Also, an image processing apparatus provided with the CPU 103, the primary storage unit 104, the image processing unit 105, the recording medium 106 and the secondary storage unit 107 may acquire an image shot by the image capturing apparatus 100, and perform processing such as tonal adjustment that depends on the shooting mode, including development processing.

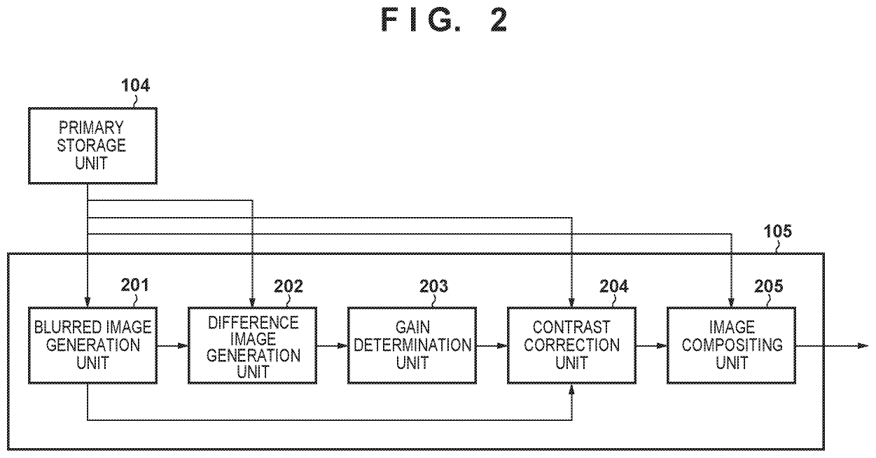

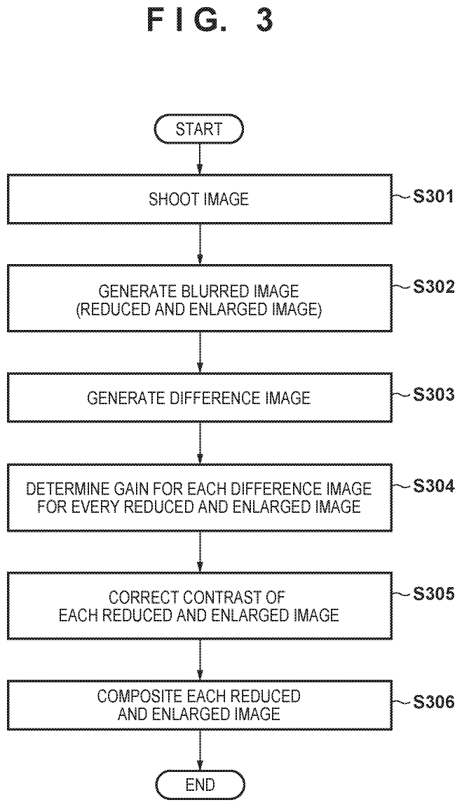

FIG. 2 is a block diagram showing a detailed configuration of the image processing unit 105 that relates to processing for generating a diorama-like image from an original image. The image processing unit 105 includes a blurred image generation unit 201, a difference image generation unit 202, a gain determination unit 203, a contrast correction unit 204, and an image compositing unit 205. Operations of the units of the image processing unit 105 will be discussed later with reference to FIG. 3.

FIG. 3 is a flowchart of diorama-like image generation processing. The processing of the steps of this flowchart is realized by the CPU 103 controlling the units of the image capturing apparatus 100 in accordance with a program, unless specifically stated otherwise.

In step S301, the CPU 103 shoots an image by controlling the optical system 101 and the image sensor 102, and stores the shot image in the primary storage unit 104.

In step S302, the blurred image generation unit 201 acquires the shot image from the primary storage unit 104, and performs reduction processing on the shot image that is acquired, and enlargement processing for returning the reduced image to the original image size. An image that is more blurred than the shot image can thereby be generated, while keeping the image size the same. In the following description, a blurred image that is obtained by reducing a shot image by a scale factor of M/N (M<N) and enlarging the reduced image to the original image size will be referred to as an “M/N reduced and enlarged image”. In this embodiment, with the purpose of generating diorama-like images that include gradual bokeh, the blurred image generation unit 201 generates a ½ reduced and enlarged image, a ¼ reduced and enlarged image, a ⅛ reduced and enlarged image, a 1/16 reduced and enlarged image, and a 1/32 reduced and enlarged image. Note that any existing method can be used as the reduction method, such as simple decimation, a bilinear method, or a bicubic method.

In the following description, a shot image that has not undergone reduction processing and enlargement processing may be called a “1/1 reduced and enlarged image”, for convenience of description. That is, except for cases where it is necessary to make a distinction, the shot image and the ½ to 1/32 reduced and enlarged images can be treated similarly as reduced and enlarged images, apart from the difference in scale factor.

In step S303, the difference image generation unit 202 acquires the shot image stored in the primary storage unit 104 and the reduced and enlarged images generated in step S302. The difference image generation unit 202 then generates a plurality of difference images which are respectively frequency components corresponding to different bands of the shot image, by calculating the difference between the reduced and enlarged images having adjacent scale factors. That is, the difference image generation unit 202 generates five difference images, by computing (shot image)−(½ reduced and enlarged image), (½ reduced and enlarged image)−(¼ reduced and enlarged image), . . . ( 1/16 reduced and enlarged image)−( 1/32 reduced and enlarged image). In the following description, a difference image that is generated by subtracting a reduced and enlarged image having an adjacent scale factor that is smaller from an M/N reduced and enlarged image will be referred to as an “MIN difference image”. For example, the difference images obtained by computing (shot image)−(½ reduced and enlarged image) and (½ reduced and enlarged image)−(¼ reduced and enlarged image) will be respectively referred to as a “1/1 difference image” and a “½ difference image”. Because the ½ reduced and enlarged image (second image) is an image from which a specific frequency component (first frequency component) of the shot image (first image) has been removed, the 1/1 difference image (first frequency component) can be acquired by subtracting the ½ reduced and enlarged image from the shot image. Similarly, the ¼ reduced and enlarged image (third image) is an image from which specific frequency components (first frequency component and second frequency component) of the shot image (first image) have been removed. Thus, the ½ difference image (second frequency component) can be acquired by subtracting the ¼ reduced and enlarged image from the ½ reduced and enlarged image. Each difference image is used as a correction component for contrast correction discussed later.

In step S304, the gain determination unit 203 acquires the difference images generated in step S303, and determines the gain to be applied to each difference image when performing contrast correction discussed later. Gain determination is performed for every reduced and enlarged image for correction.

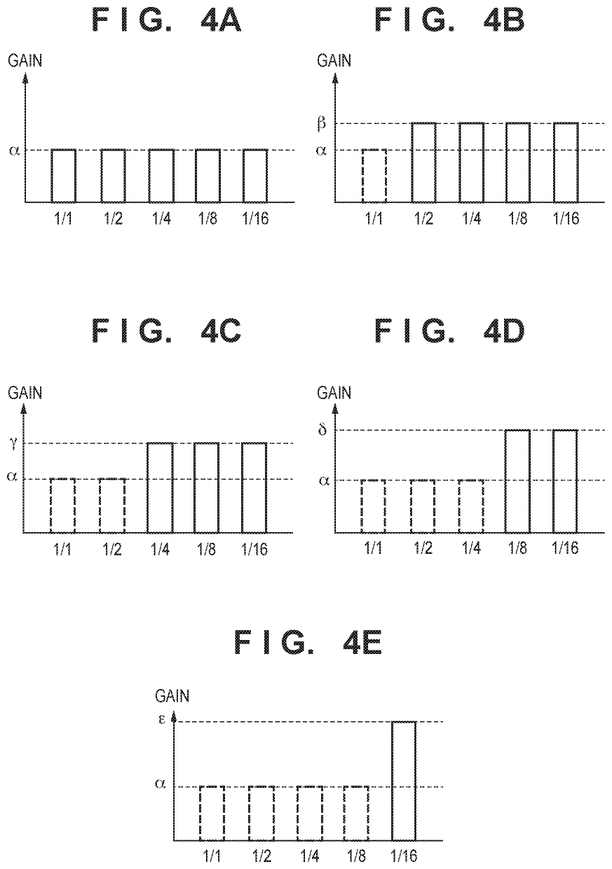

FIG. 4A is a diagram showing an example of the gain of each difference image for the 1/1 reduced and enlarged image. In this example, the gain is determined as a for all the difference images from 1/1 to 1/16. Also, FIG. 4B is a diagram showing an example of the gain of each difference image for the ½ reduced and enlarged image. Since the high frequency component of the captured image is lost due to reducing and enlarging the captured image in order to generate the ½ reduced and enlarged image, the ½ reduced and enlarged image does not have the high frequency component of the captured image. Thus, contrast is not affected even when the 1/1 difference image is added to the ½ reduced and enlarged image as a correction component. Accordingly, the gain determination unit 203 determines the gain of the 1/1 difference image as 0. On the other hand, with regard to the ½ to 1/16 difference images, the gain determination unit 203 determines the gain as β which is larger than α. Insufficient correction amount resulting from not being able to perform contrast correction using the 1/1 difference image can thereby be compensated. Similarly, FIGS. 4C to 4E are diagrams showing an example of the gain of each difference image for the ¼ to 1/16 reduced and enlarged images, respectively. Due to a similar reason for losing the high frequency component of the captured image (111 reduced and enlarged image) in the ½ reduced and enlarged image, the high frequency components of the reduced and enlarged images corresponding to the larger scale factors are lost in the ¼ to 1/16 reduced and enlarged images. Accordingly, the gain determination unit 203 determines the gain of the difference images corresponding to the larger scale factors as 0 with regard to the ¼ to 1/16 reduced and enlarged images. On the other hand, with regard to the difference images corresponding to same or smaller scale factors, the gain determination unit 203 determines the gain of each difference image, such that the gain is larger as the scale factor of the reduced and enlarged image that is targeted becomes smaller. That is, in FIGS. 4A to 4E, α<β<γ<δ<ε.

In step S305, the contrast correction unit 204 acquires the shot image (1/1 reduced and enlarged image) stored in the primary storage unit 104, the reduced and enlarged images generated in step S302, the difference images generated in step S303, and the gains determined in step S304. The contrast correction unit 204 then, with regard to the 1/1 to 1/16 reduced and enlarged images, corrects the contrast of the respective reduced and enlarged images, by applying the corresponding gain to the 1/1 to 1/16 difference images and adding the resultant images to the reduced and enlarged image that is targeted. That is, contrast correction is performed in accordance with the following equations (1) to (5).

(Corrected 1/1 reduced and enlarged image)=(original 1/1 reduced and enlarged image)+α×((1/1 difference image)+(½ difference image)+(¼ difference image)+(⅛ difference image)+( 1/16 difference image)) (1)

(Corrected ½ reduced and enlarged image)=(original ½ reduced and enlarged image)+β×((½ difference image)+(¼ difference image)+(⅛ difference image)+( 1/16 difference image)) (2)

(Corrected ¼ reduced and enlarged image)=(original ¼ reduced and enlarged image)+γ×((¼ difference image)+(⅛ difference image)+( 1/16 difference image)) (3)

(Corrected ⅛ reduced and enlarged image)=(original ⅛ reduced and enlarged image)+δ×((⅛ difference image)+( 1/16 difference image)) (4)

(Corrected 1/16 reduced and enlarged image)=(original 1/16 reduced and enlarged image)+ε×( 1/16 difference image) (5)

As can be seen from equation (1), the correction component that is added to the 1/1 reduced and enlarged image (first image) includes a component obtained by applying the gain α to the ½ difference image (second frequency component). Also, as can be seen from equation (2), the correction component that is added to the ½ reduced and enlarged image (second image) includes a component obtained by applying the gain β to the ½ difference image (second frequency component). In this embodiment, the gain α and the gain β are determined such that the gain β is larger than the gain α.

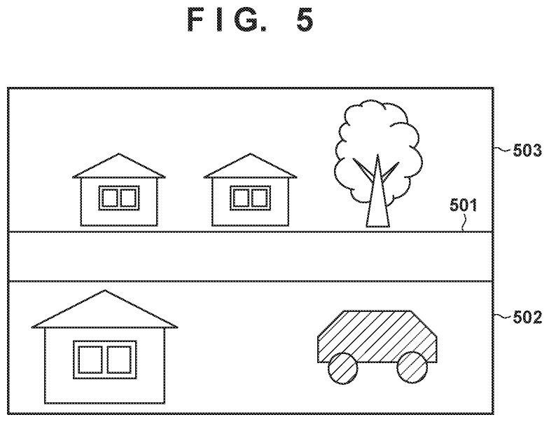

In step S306, the image compositing unit 205 generates a diorama-like image, by trimming each reduced and enlarged image (corrected image) corrected in step S305, and positioning and pasting the trimmed image with reference to the shot image that is stored in the primary storage unit 104. The image compositing unit 205, when pasting each reduced and enlarged image that has been trimmed, makes the change in the amount of bokeh in the boundary portion difficult to distinguish by smoothly mixing the boundary portion. For example, as shown in FIG. 5, the image compositing unit 205 smoothly changes the compositing ratio of a reduced and enlarged image 502 and a reduced and enlarged image 503 from 0:100 to 100:0 in an upward direction in the diagram, in a boundary portion 501 between the reduced and enlarged image 502 and the reduced and enlarged image 503. Note that, in FIG. 5, only two reduced and enlarged images are illustrated in order to simplify the description, but, in actuality, all the reduced and enlarged images corrected in step S305 are composited.

As described above, according to the first embodiment, the image capturing apparatus 100 generates 1/1 to 1/16 difference images by generating ½ to 1/32 reduced and enlarged images from a 1/1 reduced and enlarged image, and calculating the difference between the reduced and enlarged images having adjacent scale factors. The image capturing apparatus 100 then corrects the contrast of the 1/1 to 1/16 reduced and enlarged images in accordance with equations (1) to (5). The image capturing apparatus 100 determines the gain to be applied to the 1/1 to 1/16 difference images in equations (1) to (5) such that α<β<γ<δ<ε. Accordingly, it becomes possible to reduce the difference in the contrast enhancement effect between the 1/1 to 1/16 reduced and enlarged images after correction.

Note that, in this embodiment, the case where frequency components to be used as correction components for contrast correction are acquired by calculating the difference between reduced and enlarged images having adjacent scale factors and generating difference images was described as an example. However, the image capturing apparatus 100 may acquire the frequency component corresponding to each band of a shot image, with a method other than generating difference images (e.g., a method using a filter that allows each band of the shot image to pass).

Also, in this embodiment, the case where five reduced and enlarged images from ½ to 1/32 are generated from a shot image was described as an example, but the scale factors of the reduced and enlarged images is not limited to the five scale factors described above, and the number of reduced and enlarged images that are generated is also not limited to five. This embodiment is applicable in the case of generating at least one reduced and enlarged image from a shot image.

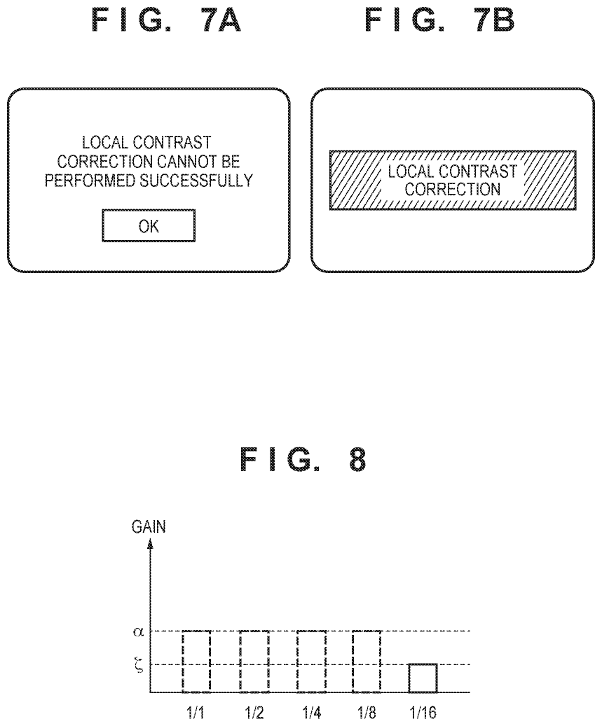

Also, in step S303 of FIG. 3, the CPU 103 may determine whether the magnitude of the generated difference images (frequency components) is less than or equal to a threshold value. In the case where the magnitude of any of the difference images (frequency components) is less than or equal to the threshold value, appropriate contrast correction cannot be performed in step S305 (a sufficient correction effect cannot be obtained). In view of this, the CPU 103 notifies the user that appropriate contrast correction cannot be performed, by displaying a dialog such as shown in FIG. 7A on the display unit 108 or graying out the setting menu item of the display unit 108 as shown in FIG. 7B, for example.

### Second Embodiment

The first embodiment described a configuration for reducing the difference in the contrast enhancement effect between images, whereas the second embodiment describes a configuration for increasing the difference in the contrast enhancement effect between images. In the second embodiment, the basic configuration of the image capturing apparatus 100 is similar to the first embodiment (refer to FIG. 1). Hereinafter, the description will focus on the differences from the first embodiment.

Note that, in the first embodiment, the case where shooting is performed in a shooting mode for generating a diorama-like image was described as an example. On the other hand, in the second embodiment, the case where shooting is performed in a shooting mode (blurred background mode) that makes the main object stand out by blurring the background will be described as an example.

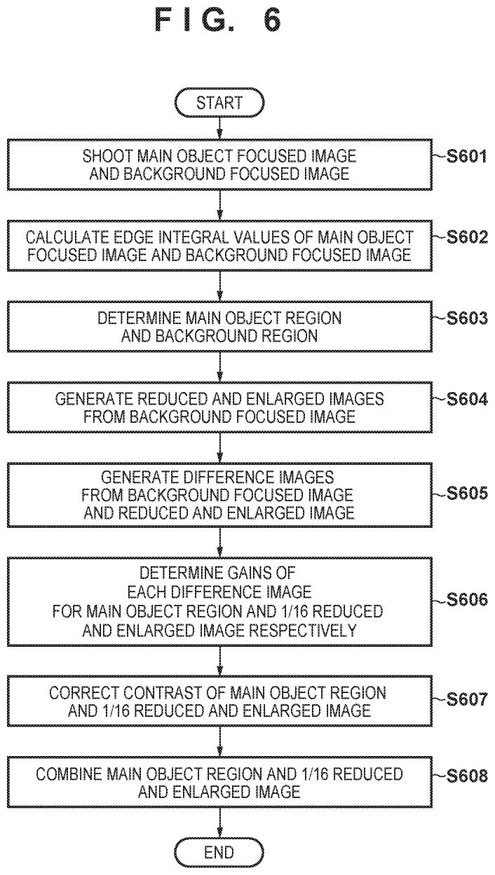

FIG. 6 is a flowchart of blurred background image generation processing. The processing of the steps of this flowchart is realized by the CPU 103 controlling the units of the image capturing apparatus 100 in accordance with a program, unless specifically stated otherwise.

In step S601, the CPU 103 shoots an image focused on a main object in the shooting range by controlling the optical system 101 and the image sensor 102, and stores the shot image (hereinafter, “main object focused image”) in the primary storage unit 104. Also, the CPU 103 shoots an image focused on the background in the shooting range by controlling the optical system 101 and the image sensor 102, and stores the shot image (hereinafter, “background focused image”) in the primary storage unit 104.

In step S602, the image processing unit 105 detects edges of the main object focused image and the background focused image. A method of detecting edges by performing bandpass filtering on the target image and acquiring an absolute value is given as an example of an edge detection method. Note that the edge detection method is not limited thereto, and other methods may be used. In the following description, an image showing edges detected from the main object focused image will be referred to as a main object edge image, and an image showing edges detected from the background focused image will be referred to as a background edge image. Next, the image processing unit 105, with regard respectively to the main object edge image and the background edge image, divides the image into a plurality of regions, and integrates absolute values of the edges of the respective regions. An edge integral value (sharpness) in each divided region [i, j] of the main object edge image is represented as EDG1[i, j], and the edge integral value in each divided region [i, j] of the background edge image is represented as EDG2[i, j].

In step S603, the image processing unit 105 compares the magnitudes of the edge integral values EDG1[i, j] and EDG2[i, j]. If the relationship EDG1[i, j]>EDG2[i, j] is satisfied, the image processing unit 105 then determines that the divided region [i, j] is a main object region, and, if this is not the case, the image processing unit 105 determines that the divided region [i, j] is a background region.

In step S604, the image processing unit 105 acquires the background focused image from the primary storage unit 104, and performs reduction processing on the acquired background focused image and enlargement processing for returning the reduced image to the original image size. An image that is more blurred than the background focused image while keeping the image size the same can thereby be generated. In the following description, the blurred image that is obtained by reducing a background focused image (first image) by a scale factor of M/N (M<N) and enlarging the reduced image to the original image size will be referred to as an “M/N reduced and enlarged image”. In this embodiment, the image processing unit 105 generates a ½ reduced and enlarged image, a ¼ reduced and enlarged image, a ⅛ reduced and enlarged image, a 1/16 reduced and enlarged image (second image), and a 1/32 reduced and enlarged image (third image).

In the following description, a background focused image that has not undergone reduction processing and enlargement processing may be referred to as “1/1 reduced and enlarged image”, for convenience of description. That is, except for cases where it is necessary to make a distinction, the background focused image and the ½ to 1/32 reduced and enlarged images can be treated similarly as reduced and enlarged images, apart from the difference in scale factor.

In step S605, the image processing unit 105 acquires the background focused image stored in the primary storage unit 104 and the reduced and enlarged images generated in step S604. The image processing unit 105 then generates a plurality of difference images which are respectively frequency components corresponding to different bands of the background focused image, by calculating the difference between the reduced and enlarged images having adjacent scale factors. That is, the image processing unit 105 generates five difference images by calculating (background focused image)−(½ reduced and enlarged image), (½ reduced and enlarged image)−(¼ reduced and enlarged image), . . . , ( 1/16 reduced and enlarged image)−( 1/32 reduced and enlarged image). In the following description, a difference image that is generated by subtracting a reduced and enlarged image having an adjacent scale factor that is smaller from an M/N reduced and enlarged image will be referred to as an “M/N difference image”. For example, the difference images obtained by computing (background focused image)−(½ reduced and enlarged image) and (½ reduced and enlarged image)−(¼ reduced and enlarged image) will be respectively referred to as a “1/1 difference image” and a “½ difference image”. The 1/32 reduced and enlarged image (third image) is an image from which a specific frequency component (second frequency component) has been removed from the 1/16 reduced and enlarged image (second image). Thus, the 1/16 difference image (second frequency component) is obtained by subtracting the 1/32 reduced and enlarged image from the 1/16 reduced and enlarged image. Each difference image is used as a correction component for contrast correction discussed later.

In step S606, the image processing unit 105 acquires the difference images generated in step S605, and determines the gain to be applied to each difference image when performing contrast correction discussed later. Gain determination is respectively performed for the main object focused image (fourth image) and the 1/16 reduced and enlarged image (second image).

FIG. 4A is a diagram showing an example of the gain of each difference image for the main object focused image. In this example, the gain is determined as a for all the difference images from 1/1 to 1/16. Also, FIG. 8 is a diagram showing an example of the gain of each difference image for the 1/16 reduced and enlarged image. Since the high frequency component of the background focused image is lost due to reducing and enlarging the background focused image in order to generate the 1/16 reduced and enlarged image, the 1/16 reduced and enlarged image does not have the high frequency component (first frequency component) of the 1/1 to ⅛ reduced and enlarged images. Thus, contrast is not affected even when the 1/1 to ⅛ difference images (first frequency component) are added to the 1/16 reduced and enlarged image as a correction component. Accordingly, the image processing unit 105 determines the gain of the 1/1 to ⅛ difference images (first frequency component) as 0. On the other hand, with regard to the 1/16 difference image (second frequency component), the image processing unit 105 determines the gain as which is smaller than a. The difference in the contrast enhancement effect between the main object focused image and the 1/16 reduced and enlarged image can thereby be increased.

In step S607, the image processing unit 105 acquires the main object focused image stored in the primary storage unit 104, the 1/16 reduced and enlarged image generated in step S604, the difference images generated in step S605, and the gains determined in step S606. The image processing unit 105 then, with regard respectively to the main object focused image and the 1/16 reduced and enlarged image, corrects the contrast of the main object focused image and the 1/16 reduced and enlarged image, by applying the corresponding gain to the 1/1 to 1/16 difference images and adding the resultant images to the image that is targeted. That is, contrast correction is performed in accordance with the following equations (6) and (7).

(Corrected main object focused image)=(original main object focused image)+β×((1/1 difference image)+(½ difference image)+(¼ difference image)+(⅛ difference image)+( 1/16 difference image)) (6)

(Corrected 1/16 reduced and enlarged image)=(original 1/16 reduced and enlarged image)+ζ×( 1/16 difference image) (7)

As can be seen from equation (6), the correction component that is added to the main object focused image (fourth image) includes a component obtained by applying the gain α to the 1/16 difference image (second frequency component). Also, as can be seen from equation (7), the correction component that is added to the 1/16 reduced and enlarged image (second image) includes a component obtained by applying the gain ζ to the 1/16 difference image (second frequency component). In this embodiment, the gain α and the gain ζ are determined such that the gain ζ is smaller than the gain α.

In step S608, the image processing unit 105 composites the main object focused image (first correction image) and the 1/16 reduced and enlarged image (second correction image) corrected in step S607 on a pixel-by-pixel basis, based on the result of the region determination in step S603. Note that, in step S603, the main object region and the background region are distinguished by binary switching. However, the main object focused image IMG1[i, j] and the 1/16 reduced and enlarged image IMG2[i, j] may be composited based on r[i,j] (0≤r≤1) that is derived by normalizing the edge integral values EDG1[i, j] and EDG2[i, j] derived in step S602. That is, the image processing unit 105 calculates the composite image B[i, j] using the following equation (8). Note that [i, j] indicates respective pixels.

B[i,j]=IMG1[i,j]×r[i,j]+IMG2[i,j]×(1−r[i,j]) (8)

As described above, according to the second embodiment, the image capturing apparatus 100 generates 1/1 to 1/16 difference images, by generating ½ to 1/32 reduced and enlarged images from a background focused image (first image), and calculating the difference between the reduced and enlarged images having adjacent scale factors. The image capturing apparatus 100 then corrects the contrast of the main object focused image (fourth image) and the 1/16 reduced and enlarged image (second image) in accordance with equations (6) and (7). The image capturing apparatus 100 determines the gain to be applied to the 1/1 to 1/16 difference images in equations (6) and (7) such that α>ζ. Accordingly, it becomes possible to increase the difference in the contrast enhancement effect between the main object focused image and the 1/16 reduced and enlarged image after correction.

Note that, in this embodiment, the case where frequency components that are used as correction components for contrast correction are acquired by calculating the difference between reduced and enlarged images having adjacent scale factors and generating difference images was described as an example. However, the image capturing apparatus 100 may acquire a frequency component corresponding to each band of a background focused image with a method other than generating difference images (e.g., a method using a filter that allows each band of the background focused image to pass).

Also, in this embodiment, the case where five reduced and enlarged images from ½ to 1/32 are generated from a background focused image was described as an example, but the scale factors of the reduced and enlarged images is not limited to the five scale factors described above, and the number of reduced and enlarged images that are generated is also not limited to five. This embodiment is applicable in the case of generating at least one reduced and enlarged image from a background focused image.

Also, in step S605 of FIG. 6, the CPU 103 may determine whether the magnitude of the 1/16 difference image (second frequency component) is less than or equal to a threshold value. In the case where the magnitude of the 1/16 difference image (second frequency component) is less than or equal to the threshold value, appropriate contrast correction cannot be performed in step S607 (a sufficient correction effect cannot be obtained). In view of this, the CPU 103 notifies the user that appropriate contrast correction cannot be performed, by displaying a dialog such as shown in FIG. 7A on the display unit 108 or graying out the setting menu item of the display unit 108 as shown in FIG. 7B, for example.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-048745, filed on, Mar. 15, 2019, which is hereby incorporated by reference herein in its entirety.

What is claimed is:

1. An image processing apparatus comprising at least one processor and/or circuit configured to function as following units:
a generation unit configured to generate, from a first image, a second image from which a first frequency component of the first image has been removed;
a correction unit configured to generate a first correction image by adding, to the first image, a first correction component that is based on the first frequency component of the first image and a second frequency component corresponding to a lower band of the first image than the first frequency component, and generate a second correction image by adding, to the second image, a second correction component that is based on the second frequency component; and
a compositing unit configured to composite the first correction image and the second correction image,
wherein the first correction component includes a component obtained by applying a first gain to the second frequency component, and the second correction component includes a component obtained by applying a second gain larger than the first gain to the second frequency component.

2. The image processing apparatus according to claim 1,
wherein the first image has a first size, and
the generation unit is configured to generate the second image from which the first frequency component of the first image has been removed, by reducing the first image to a second size smaller than the first size and enlarging the reduced image to the first size.

3. The image processing apparatus according to claim 2,
wherein the generation unit is configured to generate a third image from which the first frequency component and the second frequency component of the first image have been removed, by reducing the first image to a third size smaller than the second size and enlarging the reduced image to the first size,
the at least one processor and/or circuit is further configured to function as an acquisition unit configured to acquire the first frequency component of the first image by subtracting the second image from the first image, and acquire the second frequency component of the first image by subtracting the third image from the second image, and
the correction unit is configured to generate the first correction image and the second correction image, using the first frequency component and the second frequency component of the first image acquired by the acquisition unit.

4. The image processing apparatus according to claim 3, the at least one processor and/or circuit is further configured to function as a notification unit configured to notify a user that appropriate contrast correction cannot to be performed, in a case where a magnitude of the first frequency component or the second frequency component of the first image acquired by the acquisition unit is less than or equal to a threshold value.

5. An image capturing apparatus comprising:
the image processing apparatus according to claim 1; and
an image sensor configured to generate the first image.

6. An image processing apparatus comprising at least one processor and/or circuit configured to function as following units:
a generation unit configured to generate, from a first image focused on a background in a shooting range, a second image from which a first frequency component of the first image has been removed;
a correction unit configured to generate a first correction image by adding, to a fourth image focused on an main object in the shooting range, a first correction component that is based on the first frequency component of the first image and a second frequency component corresponding to a lower band of the first image than the first frequency component, and generate a second correction image by adding, to the second image, a second correction component that is based on the second frequency component; and
a compositing unit configured to composite the first correction image and the second correction image,
wherein the first correction component includes a component obtained by applying a first gain to the second frequency component, and the second correction component includes a component obtained by applying a second gain smaller than the first gain to the second frequency component.

7. The image processing apparatus according to claim 6,
wherein the first image has a first size, and
the generation unit is configured to generate the second image from which the first frequency component of the first image has been removed, by reducing the first image to a second size smaller than the first size and enlarging the reduced image to the first size.

8. The image processing apparatus according to claim 7,
wherein the generation unit is configured to generate a third image from which the first frequency component and the second frequency component of the first image have been removed, by reducing the first image to a third size smaller than the second size and enlarging the reduced image to the first size,
the at least one processor and/or circuit is further configured to function as an acquisition unit configured to acquire the second frequency component of the first image by subtracting the third image from the second image, and
the correction unit is configured to generate the first correction image and the second correction image, using the second frequency component of the first image acquired by the acquisition unit.

9. The image processing apparatus according to claim 8, the at least one processor and/or circuit is further configured to function as a notification unit configured to notify a user that appropriate contrast correction cannot to be performed, in a case where a magnitude of the second frequency component of the first image acquired by the acquisition unit is less than or equal to a threshold value.

10. An image capturing apparatus comprising:
the image processing apparatus according to claim 6; and
an image sensor configured to generate the first image and the fourth image.

11. An image processing method executed by an image processing apparatus, comprising:
generating, from a first image, a second image from which a first frequency component of the first image has been removed;
generating a first correction image by adding, to the first image, a first correction component that is based on the first frequency component of the first image and a second frequency component corresponding to a lower band of the first image than the first frequency component, and generating a second correction image by adding, to the second image, a second correction component that is based on the second frequency component; and
compositing the first correction image and the second correction image,
wherein the first correction component includes a component obtained by applying a first gain to the second frequency component, and the second correction component includes a component obtained by applying a second gain larger than the first gain to the second frequency component.

12. An image processing method executed by an image processing apparatus, comprising:
generating, from a first image focused on a background in a shooting range, a second image from which a first frequency component of the first image has been removed;
generating a first correction image by adding, to a fourth image focused on an main object in the shooting range, a first correction component that is based on the first frequency component of the first image and a second frequency component corresponding to a lower band of the first image than the first frequency component, and generating a second correction image by adding, to the second image, a second correction component that is based on the second frequency component; and
compositing the first correction image and the second correction image,
wherein the first correction component includes a component obtained by applying a first gain to the second frequency component, and the second correction component includes a component obtained by applying a second gain smaller than the first gain to the second frequency component.

13. A non-transitory computer-readable storage medium which stores a program for causing a computer to execute an image processing method comprising:
generating, from a first image, a second image from which a first frequency component of the first image has been removed;
generating a first correction image by adding, to the first image, a first correction component that is based on the first frequency component of the first image and a second frequency component corresponding to a lower band of the first image than the first frequency component, and generating a second correction image by adding, to the second image, a second correction component that is based on the second frequency component; and
compositing the first correction image and the second correction image,
wherein the first correction component includes a component obtained by applying a first gain to the second frequency component, and the second correction component includes a component obtained by applying a second gain larger than the first gain to the second frequency component.

14. A non-transitory computer-readable storage medium which stores a program for causing a computer to execute an image processing method comprising:
generating, from a first image focused on a background in a shooting range, a second image from which a first frequency component of the first image has been removed;
generating a first correction image by adding, to a fourth image focused on an main object in the shooting range, a first correction component that is based on the first frequency component of the first image and a second frequency component corresponding to a lower band of the first image than the first frequency component, and generating a second correction image by adding, to the second image, a second correction component that is based on the second frequency component; and
compositing the first correction image and the second correction image,
wherein the first correction component includes a component obtained by applying a first gain to the second frequency component, and the second correction component includes a component obtained by applying a second gain smaller than the first gain to the second frequency component.
